(19) United States
(12) Patent Application Publication
(10) Pub. No.: US 2003/0001836 A1
(43) Pub. Date: Jan. 2, 2003

(54) Reconstructor for and method of generating a three-dimensional representation and image display apparatus comprising the reconstructor

(76) Inventors: Fabian Edgar Ernst, Eindhoven (NL); Cornelius Wilhelmus Antonius Marie Van Overveld, Eindhoven (NL); Piotr Wilinski, Eindhoven (NL)

Correspondence Address: U.S. Philips Corporation, 580 White Plains Road, Tarrytown, NY, 10591, US

(21) Appl. No.: 10/094,122

(22) Filed: Mar. 8, 2002

(30) Foreign Application Priority Data
Mar. 12, 2001 (EP) 01200911.4

(51) Int. Cl. G06T 15/00

(52) U.S. Cl. 345/419

(57) ABSTRACT

A method of generating a three-dimensional representation (904) of at least one object (916) from multiple two-dimensional images (912) of the object makes use of an octree (902) of cells (903) to hold the three-dimensional representation (904), with each cell comprising vertices (906) and edges (910) connecting the vertices. The method is based on a process of splitting cells of the octree into smaller cells. A stop criterion for the process of splitting cells is based on inspecting which of the vertices of the cell are inside and which of the vertices are outside the object. Another stop criterion for the process of splitting a cell is based on inspecting whether the vertices of neighboring cells, are inside or outside the object.

The invention relates to a method of generating a three-dimensional representation of an object from a plurality of two-dimensional images of the object, by creating an octree of cells to hold the three-dimensional representation of the object, with each cell comprising vertices, whereby the octree of cells is created by means of a process of recursively splitting the cells of the octree into smaller cells of a next lower level of hierarchy.

The invention further relates to a reconstructor designed to generate a three-dimensional representation of an object from a plurality of two-dimensional images of the object, comprising an octree of cells to hold the three-dimensional representation of the object, with each cell comprising vertices, and the reconstructor being able to perform a process of recursively splitting the cells of the octree into smaller cells of a next lower level of hierarchy.

The invention further relates to an image display apparatus comprising:

a reconstructor designed to generate a three-dimensional representation of an object from a plurality of two-dimensional images of the object, comprising an octree of cells to hold the three-dimensional representation of the object, with each cell comprising vertices, and the reconstructor being able to perform a process of recursively splitting the cells of the octree into smaller cells of a next lower level of hierarchy.

a renderer to generate two-dimensional images from three-dimensional representations; and

a display device to display two-dimensional images.

A method of the kind described in the opening paragraph is known from T. L. Kunii et al., “A graphics compiler for a 3-dimensional captured image database and captured image reusability,” in Proceedings of IFIP workshop on Modeling and Motion Capture Techniques for Virtual Environments (CAPTECH98), Heidelberg, 1998. Springer.

The generation of three-dimensional representations out of depth data has generated a large amount of interest in the vision community. In volume-based approaches, a so-called “universe” is divided into volume elements, called voxels. Subsequent depth maps are used to decide which voxels are “empty space”, and which voxels consist of “objects”. The size of the voxels is either defined globally, or refined recursively and stored in a tree-based structure. For scenes with a lot of curved surfaces, a large amount of voxels is needed to obtain the required resolution, making storage expensive. In the cited article it is described to partially overcome these limitations by defining the essential information in the scenes as the location of the singularities and storing those in an octree. An octree is the three-dimensional equivalent of a binary tree. In an octree, each cell can be split into 8 child cells. The singularities are the vertices, edges and bounding surfaces of the objects in the scene. Each object is bounded by surfaces. The surfaces are bounded by edges. These in turn have as end points vertices. In this way each object can be built from a hierarchy of singularities, with vertices at the lowest level, then edges, then surfaces and finally the object itself. Note, however, that the hierarchy does not have to start at the vertex level, e.g. in the case of a ball. An advantage of the known method is that the subdivision stage of the octree is terminated at an early level: As soon as the structure within the cell is simple enough, i.e. if a cell contains only one singularity of the lowest order, and not only when a cell is completely inside or outside an object as with other methods.

A major obstacle in applying the known method for generating a three-dimensional representation from multiple two-dimensional images is the extraction of the singularities, i.e. essential features from the depth maps. This is a “hard” problem. First of all, accurate localization of vertices and edges from images or depth maps has already generated a vast amount of literature on, e.g., corner detectors, edge detectors and segmentation algorithms, but no suitable general purpose algorithm exists yet. Even if an adequate detector of singularities were available in two-dimensional data, these singularities might be just apparent singularities and not real ones. All locations on a curved surface seen under an angle of 90 degrees seem to be singularities in the image. Consider the situation of a ball in front of a wall. The ball has no singularity like an edge or vertex, however, in the depth map, there will seem to be a singularity at the locations which are observed under an angle of 90 degrees. From this example it can be concluded that the extraction of singularities can not be done just from a single image. The known method is interactive which means that a human operator is required. For a real-time or near real-time application, identification of singularities by a human operator is no viable solution.

It is a first object of the invention to provide a method of generating a three-dimensional representation of the kind described in the opening paragraph that is fully automatic and hence does not require interactive user input.

It is a second object of the invention to provide a reconstructor being able to generate three-dimensional representations, of the kind described in the opening paragraph fully automatic.

It is a third object of the invention to provide an image display apparatus comprising a reconstructor being able to generate three-dimensional representations, of the kind described in the opening paragraph, fully automatic.

The first object of the invention is achieved in that stopping the process of splitting a particular cell is based on inspecting which of the vertices of the particular cell are inside and which of the vertices are outside the object. This avoids the problem of singularity extraction and hence allows for a completely automatic procedure without requiring user interaction for the singularity extraction. The essence of the approach according to the prior art is that the subdivision of the octree is already halted at an early stage: as soon as the description of the object within a cell can be uniquely specified: single-singularity criterion. In the method of the invention the single-singularity criterion is replaced by: A cell should not be split if the topology of the surface within the cell can be derived uniquely from the information at the cell vertices. This is called the uniqueness criterion.

An advantage of the method according to the invention is that the storage is extremely efficient through use of the octree. Another advantage is that it allows incremental updates of the three-dimensional representation with the arrival of new images. This is very beneficial if video streams are to be processed. Another advantage is that the computational complexity is relatively low.

In an embodiment of the method according to the invention, the vertices of the particular cell are divided into a first set with vertices which are inside the object and a second set with vertices which are outside the object, with the first set and the second set comprising:

zero vertices;

one vertex; or

more than one vertex, with each vertex being connected to every other vertex of the same set by means of a set of edges, with both vertices of each of these edges belonging to the same set of vertices.

The uniqueness criterion is based on the following criterion and assumptions:

Connectivity criterion: Connectivity of vertices within the sets.

The assumption that each face and each edge of the cell is crossed by the surface not more than once.

The assumption that each object should be contained in at least two cells. This avoids cells completely containing an object.

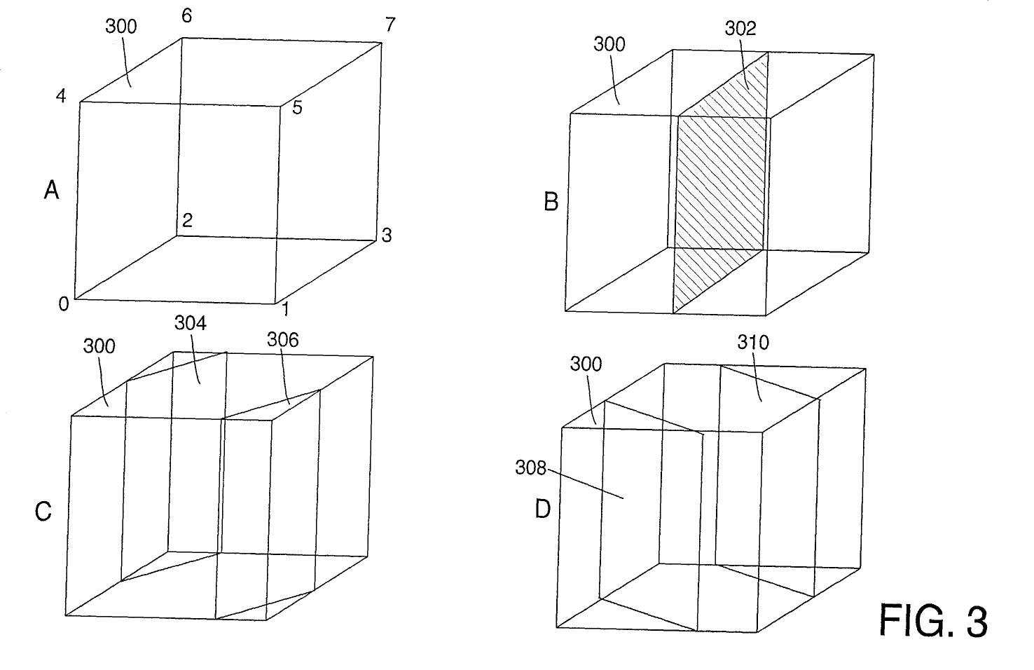

The connectivity of vertices within the sets, augmented with the checking of the above assumptions, can therefore be used as the criterion to decide whether a cell should be subdivided or not. To illustrate the uniqueness criterion, an example is given for the most simple case. In FIG. 3 this will be explained in more detail. Assume there is an octree with cells each having 8 vertices. Further it is assumed that for each cell it is known which of the 8 vertices of the cell are inside or outside an object. Then 14 basic configurations can be discerned for each cell. Of these configurations, only 8 configurations can correspond to a single-singularity cell in the sense of the prior art approach. It can be shown that for the configurations where the topology of the surface of the object can be uniquely reconstructed, the first set of vertices and the second set of vertices both form a connected set. Suppose the vertices 0, 2, 4 and 6 are in a first vertical oriented plane and the vertices 1, 3, 5 and 7 are in a second plane which is parallel with the first plane. E.g., if vertices 0, 2, 4 and 6 are inside an object, and 1, 3, 5 and 7 are outside the same object, then the surface of the object crosses the cell substantially vertically. If, in another case, vertices 0, 3, 4 and 7 are inside an object, and 1, 2, 5 and 6 are outside an object, then there are two possible configurations, i.e. ways how surfaces can intersect the cell. If either the first set or the second set is empty, the cell is completely inside or outside an object, respectively.

In an embodiment of the method according to the invention a second stop criterion for the process of splitting the particular cell is based on inspecting whether a vertex of a neighboring cell, being a cell that share either a face or an edge with the particular cell, is inside or outside the object. If neighboring cells in the octree have unequal sizes, it is known for the larger cell not only whether its vertices are inside or outside an object. It is also known for the larger cell that portions of the edges or faces are inside or outside an object. This information is based on the vertices of neighboring cells. A very important assumption in the generation of the three-dimensional representation according to the invention, is that each edge of a cell intersects the object surface at maximum once. The information of these extra points might lead to the conclusion that the single-singularity criterion is no longer satisfied. If such a situation is encountered, the larger cell has to be split; this splitting criterion is an additional criterion to the connectivity criterion discussed previously.

In an embodiment of the method according to the invention, the determination whether a vertex is inside or outside the object is based on depth-maps extracted from the two-dimensional projections. The three-dimensional representation can be created by combining information from a series of depth maps, which associate with each point on the image plane a most likely depth value. These depth maps can be created from two images using structure-from-motion algorithms, through active acquisition techniques, e.g. structured light, or passive acquisition techniques, e.g. laser scanning. Furthermore, it is assumed that the position and orientation of the camera is known, i.e. calibrated cameras are present, or have been obtained by a camera calibration algorithm.

In an embodiment of the method according to the invention, for a vertex of the particular cell a distance to a boundary of the object is calculated for generating the three-dimensional representation. If in each vertex of a cell it is stored whether it is inside or outside an object, the topology of the surface can be recovered uniquely. However, its exact location within the cell is only determined with an accuracy of the cell size. In this embodiment of the method of generating a three-dimensional representation the information in the vertex of a cell is extended with quantitative information to locate the object boundaries with higher accuracy. A way to do this is computing a signed-distance function, u from available depth maps, where u(\vec{x})=0 at the boundary of an object; u(\vec{x})>0 inside an object and u(\vec{x})<0 outside an object, with \vec{x} a vertex of an octree cell. The absolute value |u| denotes the distance to the nearest point of an object boundary, which may lie in any direction. The boundaries of the object can completely be reconstructed by computing the iso-surface u=0. This results in a gain in accuracy of the order of the cell size compared to just binary labeling: inside or outside.

In an embodiment of the method according to the invention, for a vertex of the particular cell a distance to the boundary of the object is estimated for generating the three-dimensional representation. So far, deterministic values of depth and signed-distance functions have been discussed. In reality, however, depth maps may have a stochastic nature in the sense that upper and lower bounds of the depth are given, together with the most likely depth value d_{ML}. The lower and the upper bound of this uncertainty interval are denoted with dₗ and dᵤ respectively. The depth uncertainty information allows to mitigate the effects of errors and outliers in the depth information. For each depth measurement three regions can be defined along the depth axis:

A region which is definitely outside, for d<dₗ

a region containing an object boundary, the so-called “thick wall” region, for dₗ≦d≦dᵤ and;

a region which is behind the object boundary when seen from this view point. Note that it is not definitely inside, since this region might not even contain points which are inside objects: basically there is not enough information on this region since it can not be seen from the point of view. The only thing that is known, and which might be used, is that the distance from an outside point to the object is not larger than the distance to the point corresponding with the upper bound of the depth interval.

These and other aspects of the reconstructor for and method of generating a three-dimensional representation and the image display apparatus according to the invention will become apparent from and will be elucidated with reference with respect to the implementations and embodiments described hereinafter and with reference to the accompanying drawings, wherein:

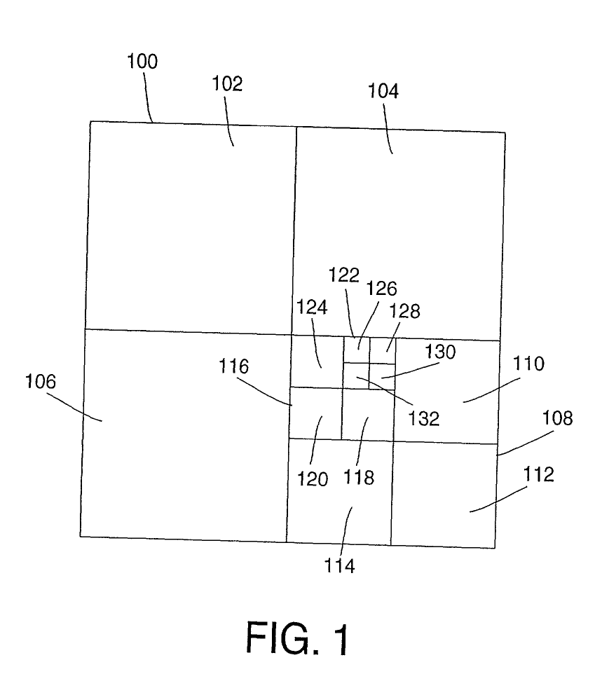

FIG. 1 schematically shows a quad-tree;

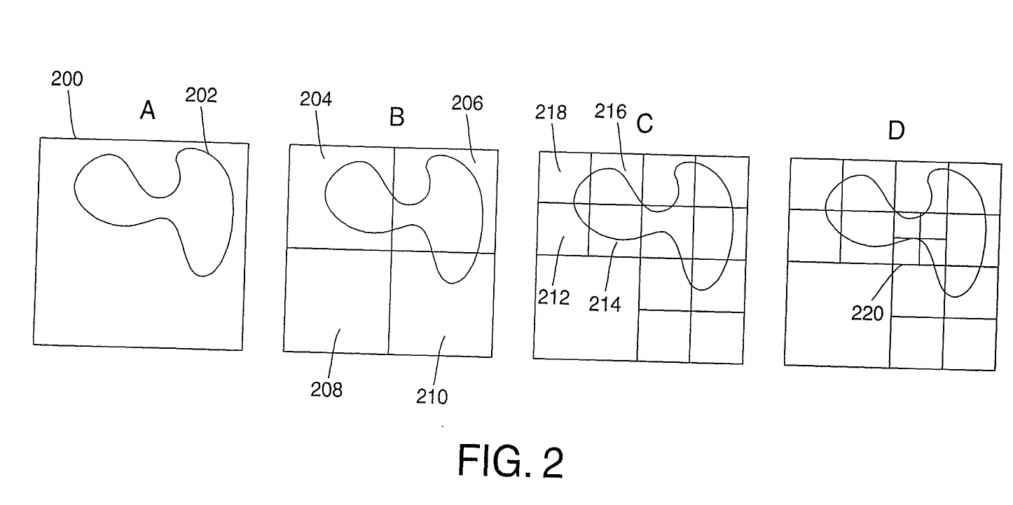

FIG. 2 schematically shows the process of splitting cells;

FIG. 3 illustrates the uniqueness criterion;

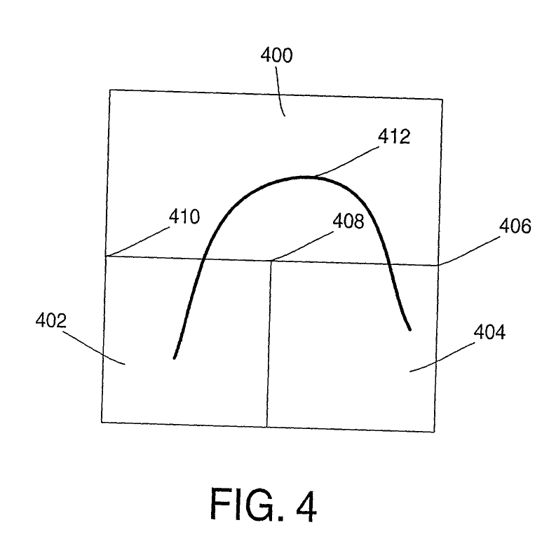

FIG. 4 illustrates the splitting criterion;

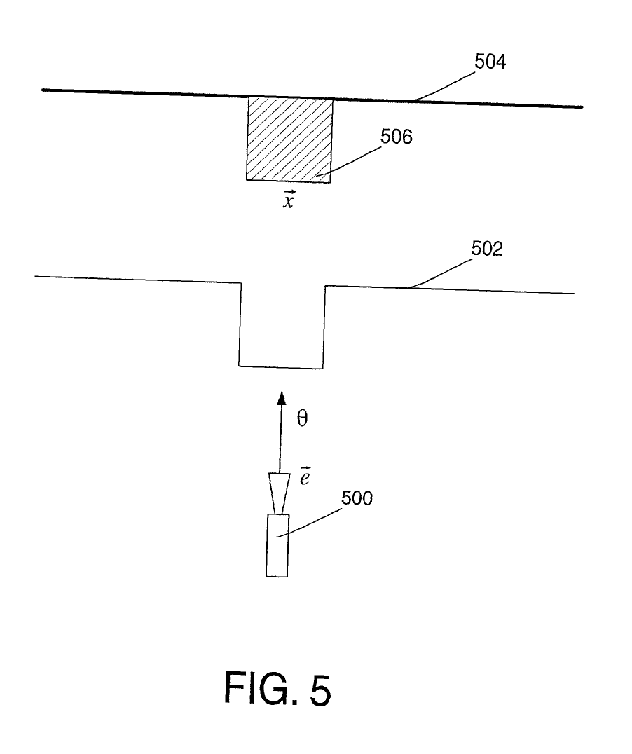

FIG. 5 schematically shows the relation between real objects and a depth-map;

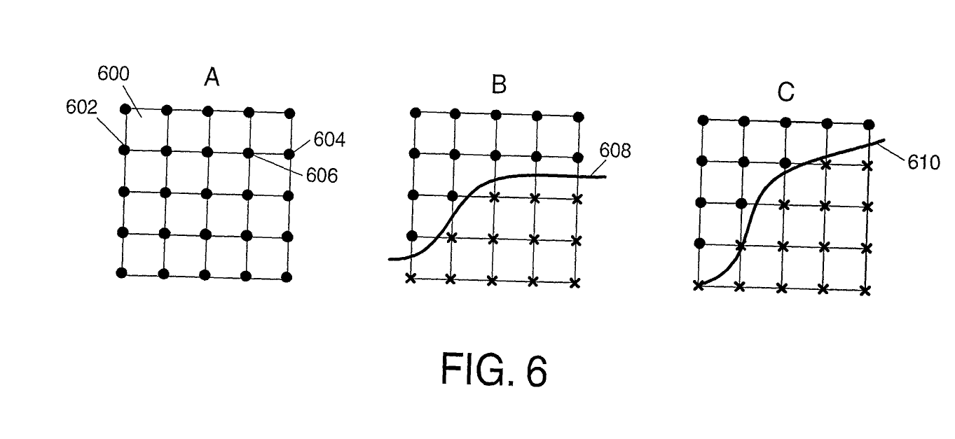

FIG. 6 schematically shows the process of categorizing vertices based on depth-maps;

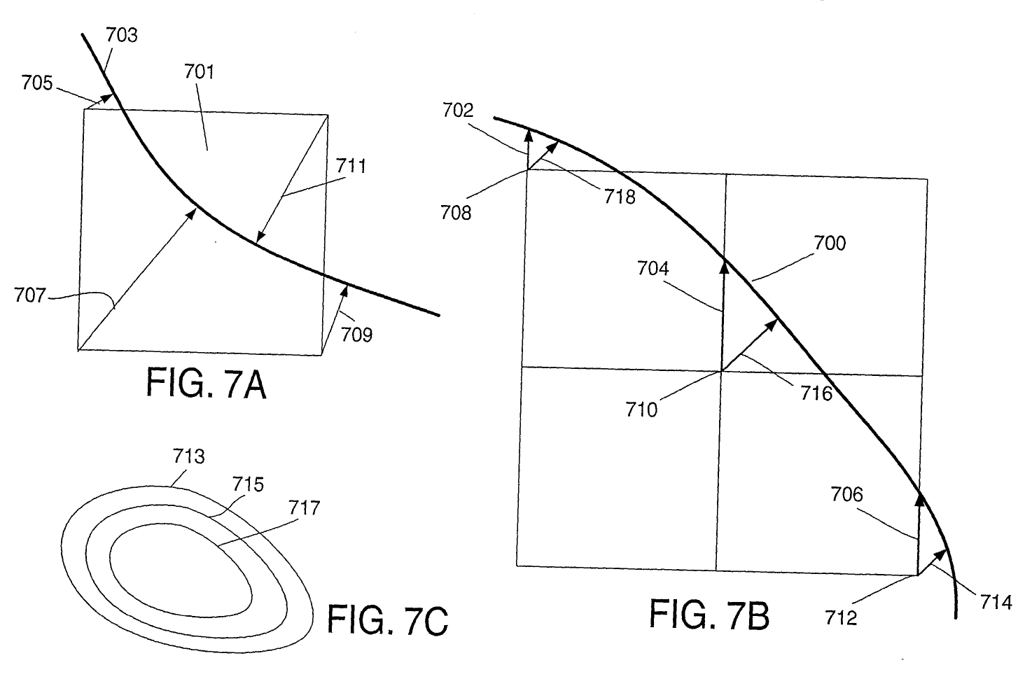

FIG. 7A shows a signed distance function;

FIG. 7B illustrates the distance between vertices and an object boundary for two different views;

FIG. 7C shows three isosurfaces;

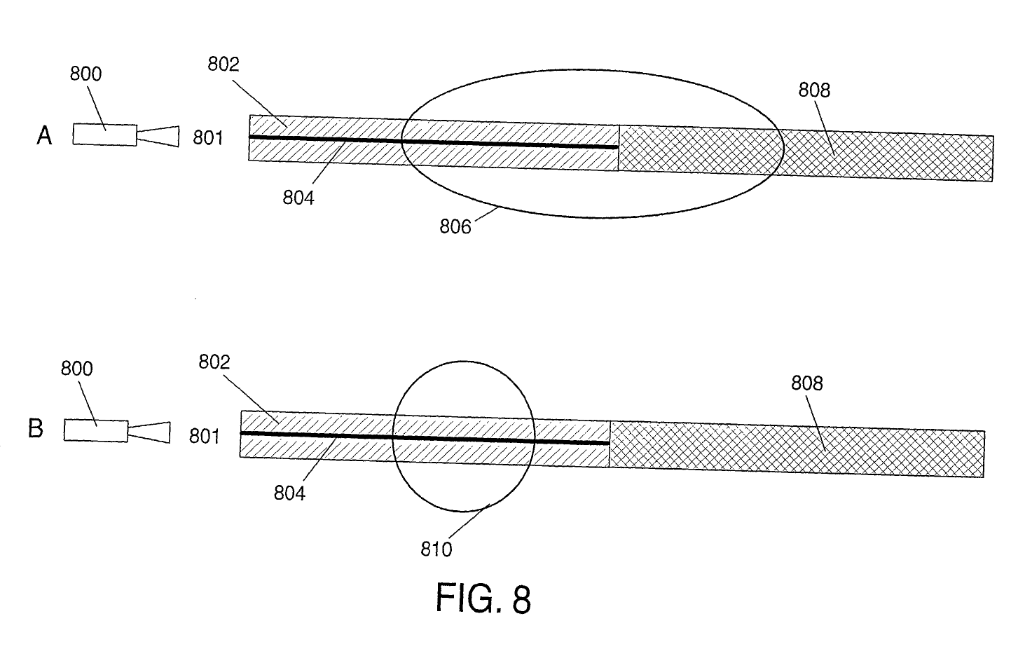

FIG. 8 illustrates the regions defined for depth measurements;

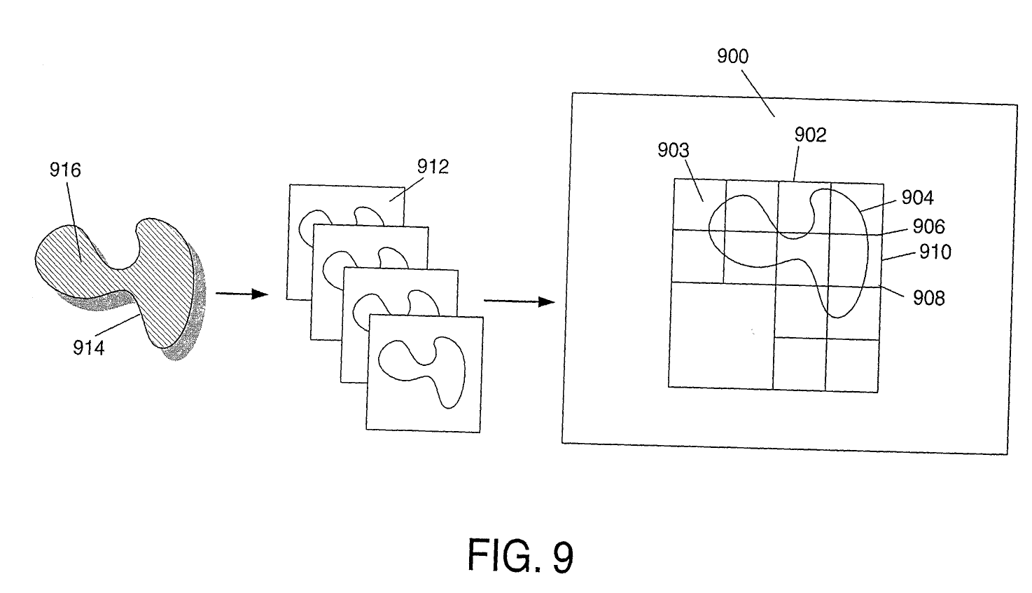

FIG. 9 illustrates the reconstructor; and

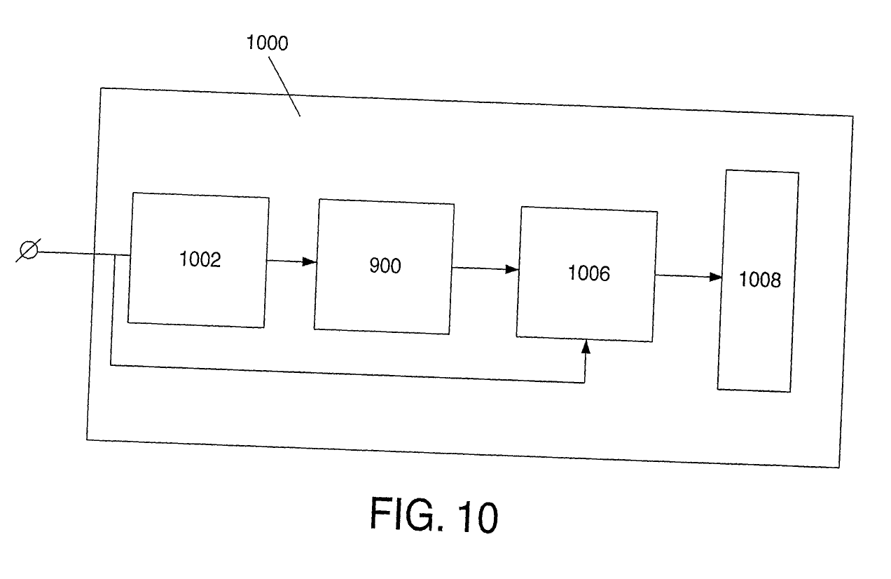

FIG. 10 shows the image display apparatus.

FIG. 1 schematically shows the two-dimensional variant of an octree: a quad-tree. The root of the tree is a two dimensional box 100. This box has four branches, i.e. is split into four smaller boxes 102-108. Box 108 on its turn has four branches, i.e. is split into four smaller boxes 110-116. Box 116 on its turn has four branches, i.e. is split into four smaller boxes 118-122. Box 122 on its turn has four branches, i.e. is split into four smaller boxes, e.g. 126-132. In the tree shown in this Fig. each time one of the boxes is split. However, each box can be split in four smaller boxes. In three-dimensions a similar tree can be created, which is called an octree. In that case a cell, instead of a box, is split into 8 smaller cells.

FIG. 2 schematically illustrates four phases: A,B,C and D of the process of splitting cells. In the initial state A the surface 202 is completely inside cell 200. After a first splitting action, leading to state B, cell 200 gets four children cells 204-208. After a subsequent group of splitting actions, leading to state C, three of these four children cells 204, 206 and 210 are split in four children cells each, e.g. 212-218 are four children cells of cell 204. One last splitting action leads to state D: Cell 220 is split into four child cells.

FIG. 3 illustrates the uniqueness criterion. The cell 300 has 8 vertices 0-7. The cell 300 is depicted four times in FIG. 3: A,B,C and D. Assume that for this cell 300, it is known for each of its 8 vertices whether they are inside or outside an object. It can be shown that for the configurations where the topology of the surface can be uniquely reconstructed, the set of “inside” vertices and the set of “outside” vertices both form a connected set. The following table shows the basic configurations. For each configuration the set of inside points is indicated and it is indicated whether the subsets are connected sets or not.

| Positions of inside points | Connectivity of subsets |
|---|---|
| — | Connected, respectively empty |
| 0 | Connected |
| 0,1 | Connected |
| 0,5 | Non-Connected |
| 0,7 | Non-Connected |
| 1,2,3 | Connected |
| 0,1,6 | Non-Connected |
| 1,4,6 | Non-Connected |
| 0,1,2,3 | Connected |
| 0,2,3,6 | Connected |
| 0,3,4,7 | Non-Connected |
| 0,2,3,7 | Connected |
| 1,2,3,4 | Non-Connected |
| 0,3,5,7 | Non-Connected |
| 1,2,3,6 | Connected |

E.g., if vertices 0, 2, 4 and 6 are inside, and 1, 3, 5 and 7 outside, the surface crosses the cell more or less vertically. This is illustrated with case B. If, on the other hand, vertices 0, 3, 4 and 7 are inside, and 1, 2, 5 and 6 are outside there are two possible configurations: C and D. With surface 304 in combination with 306 this can be achieved but also with surface 308 in combination 310. In other words, although the configuration of inside: 0, 3, 4, 7 and outside: 1, 2, 5, 6 cell vertices is exactly the same, there are two possible ways how the surfaces can intersect the cell.

FIG. 4 illustrates the splitting criterion. In FIG. 4 three neighboring cells are depicted: cell 400 and two smaller ones 402 and 404. For all vertices it is known whether they are inside or outside an object. E.g. vertices 406 and 410 are outside an object and vertex 408 is inside. A portion of a surface 412 of an object is shown. A consequence of the uniqueness assumptions is that each face and each edge of a cell may not be crossed by the surface more than once. In FIG. 4 it can be seen that one face of cell 400 is crossed twice by the surface 412 of an object. For cell 400 its is not only known whether its vertices are inside or outside an object, but this type of information is also available at another location on the edge connecting vertices 410 and 406: at the location of the vertex 408. The information of this extra vertex, from other cells, leads to the conclusion that the single-singularity criterion is no longer satisfied. In this case the larger cell 400 has to be split.

FIG. 5A shows a wall 504 with a cube 506 in front of it. The wall 504 and the cube 506 are imaged multiple times by a moving camera 500. FIG. 5 shows the camera 500 at position \vec{e} “watching” in direction θ. Point \vec{x} is a point on the surface of the cube 506. The depth-map 502 for this camera position is also shown.

FIG. 6 schematically illustrates three phases: A,B and C of the process of categorizing vertices of cells, e.g. 600. In the initial state A the vertices, e.g. 602-606, are categorized as “inside”. This is depicted with a dot for each vertex. Depth-map 608 is used to categorize the vertices. After a first processing step, leading to state B, a number of vertices are categorized as “outside”. This is depicted with crosses. Depth-map 610 is used to categorize the vertices further. After the second processing step, leading to state C, another number of vertices are categorized as “outside”, e.g. 604 and 606.

FIG. 7A shows a signed distance function, i.e. a function that defines for each vertex of a cell the distance to the nearest surface of an object. In FIG. 7A a portion of a surface 703 is located inside cell 701. The arrows 705, 707, 709 and 711 indicate the distance between vertices and the surface 703.

FIG. 7B illustrates the distance between vertices and an object boundary for two different views. The surface 700 of the object is seen from two different camera positions. For the first view the distances from the vertices 708, 710 and 712 to the surface 700 is indicated with the arrows 702, 704 respectively 706. For the second view the distances from the vertices 708, 710 and 712 to the surface 700 is indicated with the arrows 718, 716 respectively 714. It is clear that the distances, i.e. length of the arrows, in the second view are shorter than in the first view.

FIG. 7C shows three isosurfaces 713, 715 and 717. All points of such surface have the same distance to a boundary of an object:

isosurface 715 corresponds to an object boundary: u(\vec{x})=0;

isosurface 713 is located outside the object: u(\vec{x})=−1;

isosurface 717 is located inside the object: u(\vec{x})=1;

To compute the signed distance function u, u(\vec{x}|θ) is defined as the signed distance at vertex of a cell \vec{x} watched in direction θ. That means that u(\vec{x}|θ) is only related to the closest surface in direction θ. It originates from a one dimensional ray through the volume. Assume there is a depth map of a single camera with the eye at \vec{e}, then the camera is watching in direction θ=\vec{x}−\vec{e}. Then an approximation of the signed distance function u(\vec{x}|\vec{x}−\vec{e}) is given by:

$$u ( {x}^{->} \vert {x}^{->} - {e}^{->} ) = ‖ {x}^{->} - {e}^{->} ‖ - {d}_{ML} ( ξ ( {x}^{->} ) , v ( {x}^{->} ) ) \frac{‖ {x}^{->} - {e}^{->} ‖}{{k}^{->} \cdot ( {x}^{->} - {e}^{->} )} \qquad ( 1 )$$

where ξ and ν are the image-plane co-ordinates of the projections of x on the image plane, k is normal of the image plane and d_{ML} the most likely depth value. Note that u is only defined if (ξ,ν) lies within the image plane. This approximation of the signed-distance function is related to the first object boundary seen from the camera eye \vec{e} in direction \vec{x}−\vec{e}.

With a number of depth-maps a signed-distance function u can be computed incrementally, where u(\vec{x})=0 at the boundary of an object; u(\vec{x})>0 inside an object and u(\vec{x})<0 outside an object. The absolute value |u| denotes the distance to the nearest point of an object boundary, which may lie in any direction. To combine the information from multiple depth maps, it must be defined how to merge the information for u(\vec{x}|θ) into a single value for u(\vec{x}). The following two observations can be made:

The signed-distance function is defined as the distance to the closest surface in any direction (See FIG. 7A). Hence,

═u(x)l =minlu(-x|θ)I (2)

If a point is, from a certain camera view point, behind the first object boundary, it gets with equation (1) a positive value for the signed distance. However, it is not known whether the point is inside, or behind the object. On the other hand, if u(\vec{x})<0 it is known for certain that the point is outside an object: one is able to see through it. Therefore a negative value of the signed-distance function prevails over a positive one.

Even in the case where one changes from a positive to a negative value of u the absolute value should be the smaller of both: If u(\vec{x})>0, it is known that the point x is at a distance of |u| behind a boundary. If the camera would have looked from point \vec{x} in direction −(\vec{x}−{right arrow over (e))} the camera would at the latest encounter an object boundary at distance |u|. The new best approximation |u| given the current approximation of the signed-distance function uₖ and a new candidate vₖ is then the following:

|u|=min(|uₖ|,|vₖ|) with

sign(u)=1 if uₖ>0, vₖ>0 and else sign(u)=−1 (3)

In tabular form:

| Current value of signed | | Resulting value of signed |
|---|---|---|
| distance function | Measurement | distance function |
| uₖ < 0 | Vₖ < 0 | −min(\|uₖ\|,\|vₖ\|) |
| uₖ < 0 | Vₖ > 0 | −min(\|uₖ\|,\|vₖ\|) |
| uₖ > 0 | Vₖ < 0 | −min(\|uₖ\|,\|vₖ\|) |
| uₖ > 0 | Vₖ > 0 | min(\|uₖ\|,\|vₖ\|) |

FIG. 8 illustrates the regions defined for depth measurements. For each depth measurement three regions can be defined along the depth axis:

a region which is definitely outside. This is called the outside region 801

a region containing an object boundary. This is called the thick wall region 802

a region which is behind the object boundary when seen from this view point. It is called the inside region 808.

In FIG. 8 two measurements are shown. Camera 800 is watching objects. In case A the surface of the object is referenced with 806. In case B the surface of the object is referenced with 810. The measurement is referenced with 804. In case A the inside region 808 extends beyond the object bounded by surface 806. On the other hand, case B shows that the inside region 808 does not have to contain any points inside the object: due to the large error bound the complete object is already contained in the thick wall region.

Uncertainty can be incorporated by assigning to each vertex a region value which is based on the uncertainty interval bounds. This region value can be found in a similar way to the sign of the signed distance function. A table to update the region values incrementally is shown in the following table:

| Current region value | Measurement | Resulting region value |
|---|---|---|
| Outside | Outside | Outside |
| Outside | Thick wall | Outside |
| Outside | Inside | Outside |
| Thick wall | Outside | Outside |
| Thick wall | Thick wall | Thick wall |
| Thick wall | Inside | Thick wall |
| Inside | Outside | Inside |
| Inside | Thick wall | Thick wall |
| Inside | Inside | Inside |

The reasoning underlying this table is the following: If a point is seen from anywhere as being outside any object, it has been seen through it and it can not be anything else than free space. Since there is no information on the inside region, this information is overruled by thick wall information, since that means that there is an object boundary in that region. If the depth uncertainty is zero, this reduces to the signed-distance ordering relation.

Two kinds of properties on the cell vertices are specified: A signed-distance function u which is related to the maximum likelihood value of the depth, and a region value, which is related to the bounds of the depth uncertainty interval. The signed-distance function defines for each vertex of a cell the distance to the nearest surface of an object. The region value allows to deal with uncertainty, by specifying whether a vertex of a cell is outside all objects, inside an object, or in a region containing an object boundary, a so-called “thick-wall” region. The region values and signed-distance function values for the vertices are stored in one octree for efficiency. However it is possible to store the information in two separate octrees with equal structure.

The procedure to generate the three-dimensional representation is as follows.

During initialization, the boundaries of the universe to operate in are set; this is the root of the octree. Initially, the signed-distance function at each vertex of a cell in the initial structure is set to infinity and its region value to “inside”. For every depth map, the following processing sequence is then applied:

Read new depth map d, and corresponding camera parameters for image i.

Update the values for the cell vertices in the octree:

For each vertex of a cell \vec{x}ₖ in the octree, compute vₖ=u(\vec{x}ₖ|\vec{x}ₖ−\vec{e}ᵢ) according to Equation (1).

Update uₖ by finding the new best approximation from uₖ and vₖ using Equation (3)

Check for each cell whether it needs to be split according to the uniqueness criteria. If so, it is split and the vertex of a cell values are updated. This continues until no more cells need to be split.

Finally, update the region values for all cell vertices. Since this does not influence the octree structure, this can be done after all splitting has taken place.

FIG. 9 illustrates the reconstructor 900 in its context. An object 916 having a boundary 914 between its inside and its outside is imaged from multiple directions. The two-dimensional images of the object, e.g. 912, are labeled with depth-values for each pixel. The reconstructor 900 is designed to generate a three-dimensional representation 904 of the object 916 from these images. The reconstructor 900 comprises an octree 902 of cells, e.g. 903 to hold the three-dimensional representation 904. Each cell comprises vertices, e.g. 906 and 908 and edges connecting the vertices, e.g. 910. FIG. 10 shows an image display apparatus 1000 which comprises:

a depth-map generator 1002;

a reconstructor 900;

a renderer 1006; and

a display device 1008.

The input of the image display apparatus 1000 is a sequence of images. These images are processed in a number of steps. First depth-maps are generated for these images, e.g. by making use of parallax. The depth-maps are input for the reconstructor 900 which is designed to generate a three-dimensional representation of objects in the imaged scene. The incoming images represent these objects. The output of the reconstructor 900, being a three-dimensional representation of objects is input for the renderer 1006. The renderer 1006 is able to generate two-dimensional images from three-dimensional representations. These generated images may correspond to views which have not originally been made by the camera capturing the scene. The generated two-dimensional images are displayed by the display device 1008. The display device 1008 might be a regular display device but it might also be a type that is able to display pairs or groups of images representing views from slightly different angles: a stereoscopic display device respectively a “multiscopic” display device with e.g. a lenticular screen. For performance reasons the depth-map generator 1002, reconstructor 900 and renderer 1006 might be implemented on silicon, i.e. dedicated hardware. In case of less performance critical circumstances a programmable hardware platform might be sufficient to realize these three devices.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word “comprising” does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of generating a three-dimensional representation (904) of an object (916) from a plurality of two-dimensional images (912) of the object, by creating an octree (902) of cells (903) to hold the three-dimensional representation of the object (904), with each cell (903) comprising vertices (906), whereby the octree of cells is created by means of a process of recursively splitting the cells (903) of the octree (902) into smaller cells of a next lower level of hierarchy, characterized in that stopping the process of splitting a particular cell (903) is based on inspecting which of the vertices (906) of the particular cell (903) are inside and which of the vertices (906) are outside the object (916).

2. A method as claimed in claim 1, characterized in that the vertices (906) of the particular cell (903) are divided into a first set with vertices which are inside the object (916) and a second set with vertices which are outside the object (916), with the first set and the second set comprising:
zero vertices;
one vertex; or
more than one vertex, with each vertex being connected to every other vertex of the same set by means of a set of edges, with both vertices of each of these edges belonging to the same set of vertices.

3. A method as claimed in claim 2, characterized in that a second stop criterion for the process of splitting the particular cell (400) is based on inspecting whether a vertex (408) of a neighboring cell (402), is inside or outside the object (412).

4. A method as claimed in claim 3, characterized in that the vertex (408) of the neighboring cell (402) is inspected if the neighboring cell (402) is smaller than the particular cell (400).

5. A method as claimed in claim 4, characterized in that depth-maps (502), extracted from the two-dimensional images(912), are used as a bases for determining whether a vertex (906) is inside or outside the object (916).

6. A method as claimed in claim 5, characterized in that for a vertex of the particular cell (701) a distance (705) to a boundary (703) of the object is calculated for generating the three-dimensional representation (904).

7. A method as claimed in claim 5, characterized in that for a vertex of the particular cell a distance to the boundary of the object (806) is estimated for generating the three-dimensional representation (904).

8. A reconstructor (900) designed to generate a three-dimensional representation (904) of an object (916) from a plurality of two-dimensional images (912) of the object (916), comprising an octree (902) of cells (903) to hold the three-dimensional representation of the object (904), with each cell (903) comprising vertices (906), and the reconstructor being able to perform a process of recursively splitting the cells (903) of the octree (902) into smaller cells of a next lower level of hierarchy, characterized in that the reconstructor (900) is designed to inspect which of the vertices (906) of a particular cell (903) are inside and which of the vertices are outside the object (916) in order to be able to decide to stop the process of splitting the particular cell (903).

9. A reconstructor (900) as claimed in claim 8, characterized in being designed to inspect whether a vertex (408) of a neighboring cell (402), is inside or outside the object in order to be able to decide to stop the process of splitting the particular cell (400).

10. A reconstructor (900) as claimed in claim 9, characterized in being designed to determine whether a vertex is inside or outside the object based on depth-maps (502) extracted from the two-dimensional images(912).

11. A reconstructor as claimed in claim 10, characterized in being designed to calculate for a vertex of the particular cell (701) a distance (705) to the boundary (703) of the object for generating the three-dimensional representation (904).

12. A reconstructor (900) as claimed in claim 10, characterized in being designed to estimate for a vertex of the particular cell a distance to the boundary of the object for generating the three-dimensional representation (904).

13. An image display apparatus (1000) comprising:
a reconstructor (900) designed to generate a three-dimensional representation (904) of an object (916) from a plurality of two-dimensional images (912) of the object (916), comprising an octree (902) of cells (903) to hold the three-dimensional representation of the object (904), with each cell (903) comprising vertices (906), and the reconstructor being able to perform a process of recursively splitting the cells (903) of the octree (902) into smaller cells of a next lower level of hierarchy;
a renderer (1006) to generate two-dimensional images from three-dimensional representations; and
a display device (1008) to display two-dimensional images, characterized in that the reconstructor (900) is designed to inspect which of the vertices of a particular cell are inside and which of the vertices are outside the object in order to be able to stop the process of splitting the particular cell.
